(19) United States
(12) Patent Application Publication
(10) Pub. No.: US 2015/0123884 A1
(43) Pub. Date: May 7, 2015

(54) ORGANIC LIGHT EMITTING DISPLAY APPARATUS

(71) Applicant: SAMSUNG DISPLAY CO., LTD., Yongin-City (KR)

(72) Inventor: Dong-Gyu Kim, Yongin-City (KR)

(21) Appl. No.: 14/296,161

(22) Filed: Jun. 4, 2014

(30) Foreign Application Priority Data
Nov. 6, 2013 (KR) 10-2013-0134360

(51) Int. Cl. G09G 3/32

(52) U.S. Cl. CPC G09G 3/3225; G09G 3/3266; G09G 3/3275; G09G 2330/10; G09G 2330/08; G09G 2300/0809; G09G 2300/0426; G09G 2300/0413
USPC 345/77; 345/76; 345/82

(57) ABSTRACT

An organic light emitting display apparatus includes: an emission pixel including a pixel circuit coupled to a first voltage line configured to apply a first voltage and to transmit the first voltage according to a logic level of a data signal applied in units of a subfield, and a plurality of sub-light-emitting devices coupled to the pixel circuit and configured to receive the first voltage to emit light; a dummy pixel coupled to the first voltage line or a second voltage line configured to apply a second voltage having a level higher than that of the first voltage; and a repair line coupling a first sub-light-emitting device among the plurality of the sub-light-emitting devices separated from the emission pixel to the dummy pixel to provide a pathway for transmitting the first voltage or the second voltage to the first sub-light-emitting device according to a logic level of a dummy data signal.

### CROSS-REFERENCE TO RELATED APPLICATION

This application claims priority to and the benefit of Korean Patent Application No. 10-2013-0134360, filed on Nov. 6, 2013, in the Korean Intellectual Property Office, the disclosure of which is incorporated herein in its entirety by reference.

### BACKGROUND

1. Field

One or more embodiments of the present invention relate to organic light emitting display apparatuses and methods of repairing the same.

2. Description of the Related Art

When defects occur in a certain pixel, the certain pixel may always generate light regardless of whether scanning signals and data signals are supplied to the certain pixel. A pixel that always generates light, such as the pixel described above, may be recognized as a bright spot (or a hot spot) and the bright spot may be easily observed by an observer due to its high visibility.

Because an organic light emitting display apparatus has a complicated pixel circuit and a cumbersome manufacturing process, manufacturing a large and high resolution organic light emitting display apparatus may increase the number of defective pixels, which may decrease production yield.

### SUMMARY

Aspects of one or more embodiments of the present invention are directed toward digitally driven organic light emitting display apparatuses capable of repairing defective pixels for a normal operation thereof to increase production yield and reduce product quality deterioration.

Additional aspects will be set forth in part in the description which follows and, in part, will be apparent from the description, or may be learned by practice of the presented embodiments.

According to one or more embodiments of the present invention, an organic light emitting display apparatus includes: an emission pixel including a pixel circuit coupled to a first voltage line configured to apply a first voltage and to transmit the first voltage according to a logic level of a data signal applied in units of a subfield, and a plurality of sub-light-emitting devices coupled to the pixel circuit and configured to receive the first voltage to emit light; a dummy pixel coupled to the first voltage line or a second voltage line configured to apply a second voltage having a level higher than that of the first voltage; and a repair line coupling a first sub-light-emitting device among the plurality of the sub-light-emitting devices separated from the emission pixel to the dummy pixel to provide a pathway for transmitting the first voltage or the second voltage to the first sub-light-emitting device according to a logic level of a dummy data signal.

The pixel circuit of the emission pixel may include: a first thin film transistor configured to be turned on by a scan signal applied to a scan line and to transmit the data signal applied to a data line; a second thin film transistor configured to be turned on according to a logic level of the data signal and to transmit the first voltage to the plurality of sub-light-emitting devices; and a first capacitor configured to store a voltage corresponding to the data signal.

Each of the sub-light-emitting devices may include: a first electrode coupled to the pixel circuit; a second electrode opposite to the first electrode; and an emission layer between the first electrode and the second electrode.

The dummy pixel may include: a third thin film transistor configured to be turned on by a scan signal applied to a scan line and to transmit the dummy data signal applied to a dummy data line; a fourth thin film transistor configured to be turned on according to a logic level of the dummy data signal and to transmit the first voltage or the second voltage to the repair line; and a second capacitor configured to store a voltage corresponding to the dummy data signal.

The dummy data signal may be a data signal applied to the emission pixel.

The first sub-light-emitting device may include all of the plurality of the sub-light-emitting devices, and the dummy pixel may be coupled to the first voltage line and configured to transmit the first voltage to the first sub-light-emitting device through the repair line.

The first sub-light-emitting device may include some of the plurality of the sub-light-emitting devices, and the dummy pixel may be coupled to the second voltage line and configured to transmit the second voltage to the first sub-light-emitting device through the repair line.

The dummy pixel may be at a same row as the emission pixel and configured to concurrently receive a same scan signal as that of the emission pixel.

The emission pixel may be configured to receive a data signal from a data line, the dummy pixel may be configured to receive a dummy data signal from a dummy data line, the dummy data signal may be a signal supplied to the dummy data line through a coupling line coupled to each of the data line and the dummy data line.

The organic light emitting display apparatus may further include: a scan driver configured to supply a scan signal to a scan line coupled to the emission pixel and the dummy pixel; a data driver configured to supply a data signal through a data line coupled to the emission pixel and a dummy data signal through a dummy data line coupled to the dummy pixel; and a power supplier configured to supply the first voltage and the second voltage.

One frame may include a plurality of subfields, and the organic light emitting display apparatus may be configured to display a gray level by selectively illuminating the emission pixel according to a logic level of the data signal supplied to each subfield to control emission time.

In another embodiment of the present invention, there is provided an organic light emitting display apparatus, which displays a gray level by forming one frame into a plurality of subfields, the organic light emitting display apparatus including: a display panel including an emission pixel in a display area including a plurality of sub-light-emitting devices in which emission is controlled according to a logic level of a data signal supplied at each subfield, a dummy pixel in a dummy area adjacent the display area and configured to repair defects of the emission pixel, and a repair line electrically separated from the emission pixel and the dummy pixel; and a power supplier configured to supply a first power supply voltage, the first power supply voltage being a first voltage or a second voltage having a higher level than that of the first voltage and a second power supply voltage having a lower level than that of the first power supply voltage.

The emission pixels may include: a first thin film transistor configured to be turned on by a scan signal supplied to a scan line and to transmit a data signal supplied to a data line; a second thin film transistor configured to be turned on according to a logic level of the data signal and to transmit the first voltage to the plurality of the sub-light-emitting devices; and a first capacitor configured to store a voltage corresponding to the data signal.

Each sub-light-emitting device may include: a first electrode coupled to the second thin film transistor; a second electrode opposite to the first electrode; and an emission layer between the first electrode and the second electrode.

The dummy pixel may include: a third thin film transistor configured to be turned on by a scan signal supplied to a scan line and to transmit a dummy data signal supplied to a dummy data line; a fourth thin film transistor configured to be turned on according to a logic level of the dummy data signal and to transmit the first voltage or the second voltage through the repair line; and a second capacitor configured to store a voltage corresponding to the dummy data signal.

When a pixel circuit of the emission pixel is defective, the plurality of the sub-light-emitting devices may be configured to be electrically separated from the emission pixel and to be each electrically coupled to the repair line, and the dummy pixel may be configured to be electrically coupled to each of a first voltage line configured to supply the first voltage and the repair line.

When one of the plurality of sub-light-emitting devices of the emission pixel is defective, the plurality of sub-light-emitting devices may be configured to be electrically separated from the emission pixel, and sub-light-emitting devices other than the defective sub-light-emitting device may be configured to be electrically coupled to the repair line, and the dummy pixel may be electrically coupled to each of a second voltage line configured to supply the second voltage and the repair line.

The organic light emitting display apparatus may further include: a scan driver configured to supply a scan signal to a scan line coupled to the emission pixel and the dummy pixel; and a data driver configured to supply a data signal to a data line coupled to the emission pixel and to supply a dummy data signal to a dummy data line coupled to the dummy pixel.

A dummy data signal may be a data signal to be applied to the emission pixel.

The organic light emitting display apparatus may further include: a scan driver configured to supply a scan signal to a scan line coupled to the emission pixel and the dummy pixel; and a data driver configured to supply a data signal to a data line coupled to the emission pixel; and a coupling line coupled to the data line and a dummy data line which is coupled to the dummy pixel and configured to supply the data signal supplied to the data line to the dummy data line.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram schematically illustrating a display apparatus according to an embodiment of the present invention;

FIGS. 2 and 3 are timing charts illustrating a method of driving the display panel illustrated in FIG. 1;

FIGS. 4, 5, and 6 illustrate a method of repairing a defective pixel by using (utilizing) a repair line;

FIG. 7 is a circuit diagram illustrating an emission pixel (EP) according to an embodiment of the present invention;

FIG. 8 is a circuit diagram illustrating a dummy pixel (DP) according to an embodiment of the present invention;

FIGS. 9 and 10 illustrate a method of repairing a defective pixel by using a repair line according to an embodiment of the present invention; and

FIG. 11 is a block diagram schematically illustrating a display apparatus according to another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the present invention will be described in detail with reference to the drawings and repetitive descriptions will be omitted.

It will be understood that although the terms “first”, “second”, etc. may be used herein to describe various components, these components should not be limited by these terms. These components are only used to distinguish one component from another. Also, in the embodiments described below, a singular expression includes a plural expression, unless clearly stated otherwise.

In the embodiments below, the terms such as “includes” and “has” are used to indicate that corresponding characteristics or features exist, but the terms do not exclude additional characteristics or features.

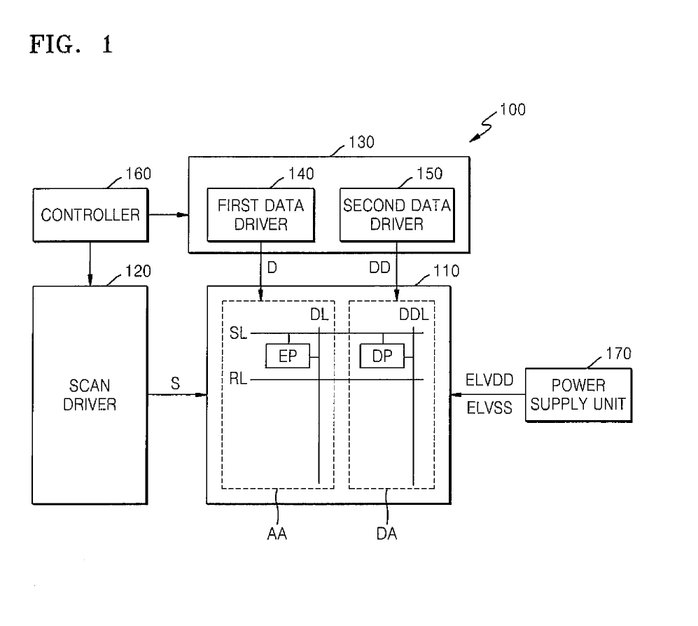

FIG. 1 is a block diagram schematically illustrating a display apparatus according to an embodiment of the present invention.

Referring to FIG. 1, a display apparatus 100 according to an embodiment of the present invention may include a display panel 110, a scan driver 120, a data driver 130, a controller 160, and a power supply unit (or a power supplier) 170. The scan driver 120, the data driver 130, and the controller 160 may each be formed as a separate integrated circuit chip or as one integrated circuit chip to then be directly mounted on a display panel 110 or a flexible printed circuit film, may be attached to a display panel 110 or mounted on a separate printed circuit board in the form of a tape carrier package (TCP), or may be formed on the same substrate as that of the display panel 110.

The display panel 110 may include a display area AA and a dummy area DA, which is a part of a non-display area near the display area AA. The dummy area DA may be located in at least one area on the left-side or the right-side of the display area AA. A plurality of emission pixels EPs coupled (e.g., connected) to a scanning line SL and a data line DL are in the display area AA, and at least one dummy pixel coupled to the scanning line SL and a dummy data line DDL is in the dummy area DA. The display panel 110 may include a repair line RL, which is in parallel to the scanning line SL.

The repair line RL couples (e.g., connects) a light-emitting device that has been separated from a defective (faulty) emission pixel EP to the dummy pixel DP, in order to provide a pathway for controlling emission of the emission pixel EP according to a logic level of a dummy data signal applied to the dummy pixel DP. The repair line RL may be in units of a unit pixel (e.g., may correspond to each unit pixel) or may be in units of a plurality of sub-pixels in the unit pixel (e.g., may correspond to a plurality of sub-pixels in the unit pixel).

The scan driver 120 may generate and supply a scan signal S to the emission pixel EP and the dummy pixel DP at set time (e.g., a predetermined time) through the scan line SL.

The data driver 130 may provide a data signal D having any one of a first logic level and a second logic level to each emission pixel EP through a plurality of the data lines DL. The first logic level and the second logic level may be a high level and a low level, respectively. Also, the first logic level and the second logic level may be a low level and a high level, respectively. The data driver 130 may include a first data driver 140 and a second data driver 150.

The first data driver 140 may receive video data of the emission pixels EP in one frame to extract gray level (gradation) per emission pixel EP, and transform extracted gray level into digital data having a bit number (e.g., a predetermined bit number). The first data driver 140 may provide each bit included in digital data to each emission pixel EP as a data signal D per subfield. One frame includes a plurality of subfields, and each subfield has display duration set according to its weight.

The display apparatus 100 selectively turns on a light-emitting device included in each emission pixel EP based on (or according to) the logic level of the data signal D provided from the first data driver 140 for each subfield to adjust emission duration of the light-emitting device in one frame to thus display the gray level. When each emission pixel EP receives a low level data signal, the light-emitting device is turned-on for the duration of the corresponding subfield, and when the emission pixel EP receives a high level data signal, the light-emitting device may be turned-off for the duration of the corresponding subfield. In other embodiments, when each emission pixel EP receives a high level data signal, the light-emitting device is turned-on for the duration of the corresponding subfield, and when the emission pixel EP receives a low level data signal, the light-emitting device may be turned-off for the duration of the of the corresponding subfield.

The second data driver 150 may generate and supply a dummy data signal DD to the dummy pixel DP through the dummy data line DDL. When the emission pixel EP and the dummy pixel DP, which are electrically coupled through the repair line RL, receive an identical scan signal S, the second data driver 150 may supply the same data signal to the dummy pixel DP as the data signal D supplied to the emission pixel EP.

When the dummy data signal DD is supplied to a repaired defective emission pixel EP (hereinafter, repair pixel or defective pixel EPerr) through the repair line RL, the second data driver 150 may supply the data signal D supplied to the repair pixel (or defective pixel) EPerr to the dummy pixel DP as the dummy data signal.

FIG. 1 shows an embodiment in which the first data driver 140 and the second data driver 150 are integrated as one, but embodiments of the present invention are not limited thereto, and the second data driver 150 may be separated from the first data driver 140.

The controller 160 generates a scan control signal and a data control signal and delivers the signals to the scan driver 120 and the data driver 130, respectively. As a result, the scan driver 120 supplies the scan signal S to each scan line SL at set times (e.g., predetermined times) for each subfield, and the data driver 130 supplies the data signal D to each emission pixel EP and supplies the dummy data signal DD to the dummy pixel DP used for repair.

The power supply unit 170 receives external power and/or internal power to transform the power to voltages of various levels, which are for driving each component and for supplying the corresponding voltage to the display panel 110 according to a power control signal input from the controller 160. The power supply unit 170 may use a direct current-direct current (DC-DC) converter.

The power supply unit 170 may supply a first power source voltage ELVDD and a second power source voltage ELVSS to the emission pixel EP and the dummy pixel DP of the display panel 110. The first power source voltage ELVDD may be a high level voltage (e.g., a predetermined high level voltage) and the second power source voltage ELVSS may be a voltage that is lower than the first power source voltage ELVDD or a ground voltage. The first power source voltage ELVDD may be a first voltage ELVDD1, or a second voltage ELVDD2, which is at a higher level than that of the first voltage ELVDD1. In one embodiment, the second power source voltage ELVSS has a lower level than that of the first voltage ELVDD1.

The power supply unit 170 may supply the first voltage ELVDD1 and the second power source voltage ELVSS to the emission pixel EP, and supply the first voltage ELVDD1 or the second voltage ELVDD2, and the second power source voltage ELVSS to the dummy pixel DP.

In the embodiment of FIG. 1, the dummy area DA is on the right side of the display area AA; however, the present invention is not limited thereto and the dummy area DA may be at the right side and/or the left side of the display area AA.

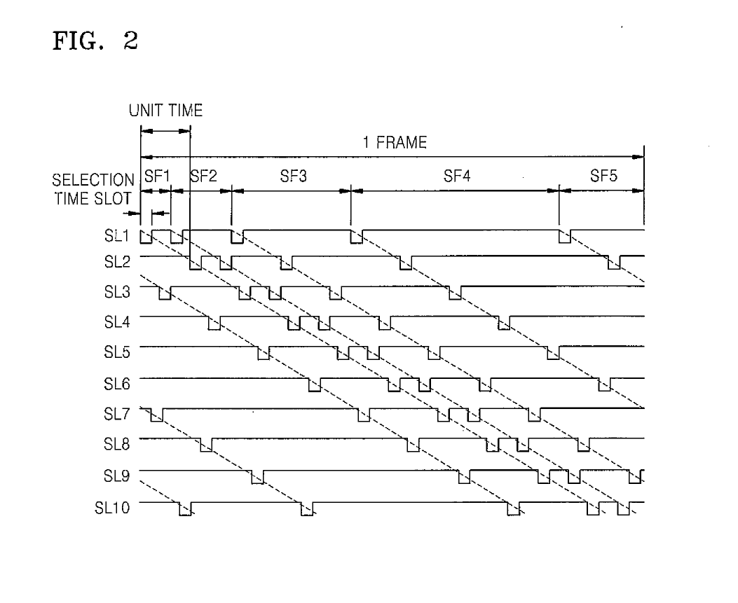

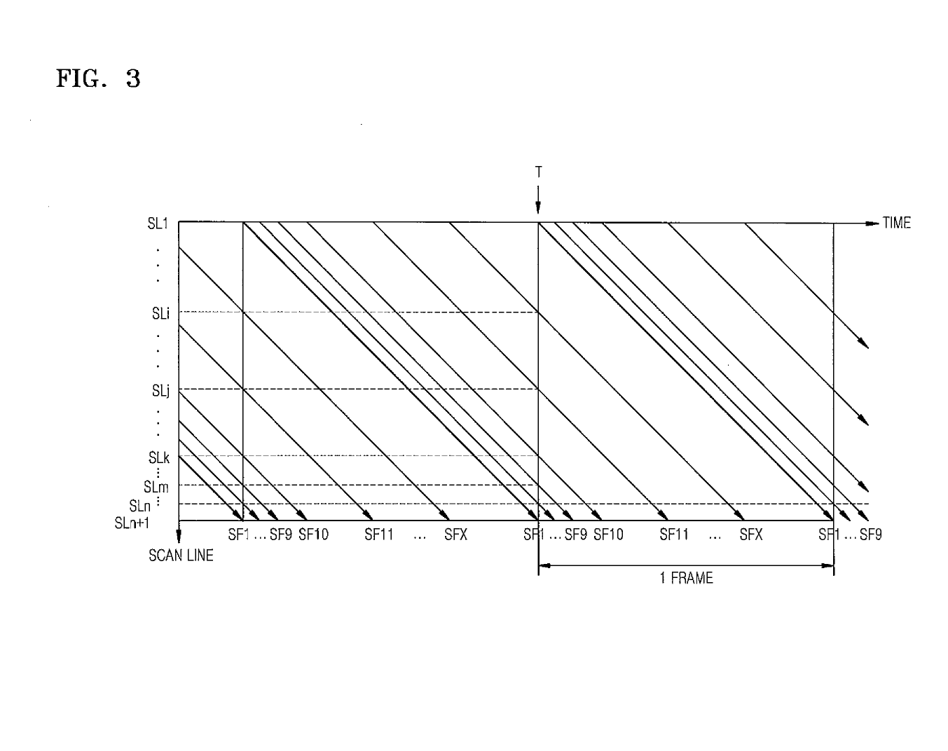

FIGS. 2 and 3 are timing charts describing a method of operating the display panel illustrated in FIG. 1.

FIG. 2 illustrates an embodiment in which first through tenth scan lines (SL1 through SL10) are controlled. Referring to FIG. 2, one frame may include first through fifth subfields (SF1 through SF5) and thus may be displayed in gray level by five pieces of first through fifth bit data. One unit time includes five selection time slots. A length of the display duration (number of selection time slots) of each piece of bit data is 3:6:12:21:8 and thus, a sum of display durations of the five pieces of bit data is 50 (=3+6+12+21+8) selection time slots. A selection time of each scan line per subfield may be delayed by one unit time than a selection time of a previous scan line.

To enable the scan driver 120 to select one scan line at a time, one unit time is time divided into five selection time slots. For example, in one unit time, the first scan line SL1 is selected for the first selection time slot, the seventh scan line SL7 is selected for the second selection time slot, the third scan line SL3 is selected for the third selection time slot, the first scan line SL1 is selected for the fourth selection time slot, the tenth scan line SL10 is selected for the fifth selection time slot, such that the first bit data, the fourth bit data, the fifth bit data, the second bit data, and the third bit data are respectively supplied to the emission pixel EP.

When the dummy pixel DP is used for repair, bit data that is supplied to the repair pixel (or defective pixel) EPerr in the same pixel row as the dummy pixel DP is applied to the dummy pixel DP at the time during which the scan line coupled to the dummy pixel DP is selected.

FIG. 3 illustrates an example in which the first through the (n+1)^{th} scan lines (SL1 through SLn+1) are controlled. Referring to FIG. 3, one frame includes a plurality of subfields, namely, the first through the X^{th} subfields (SF1 through SFX) to display a gray level by X pieces of the first through the X^{th} bit data. One unit time includes the X selection time slots. For each subfield, the selection time of each scan line is delayed by one unit time than the selection time of the previous scan line.

To enable the scan driver 120 to select one scan line at a time, one unit time is time divided into X selection time slots. Also, the scan driver 120 may be set such that the scan lines are selected in a time-shared manner even in one selection time, such as time T, during which a plurality of scan lines (SL1, SLi, SLj, SLk, SLm, SLn, SLn+1) are selected.

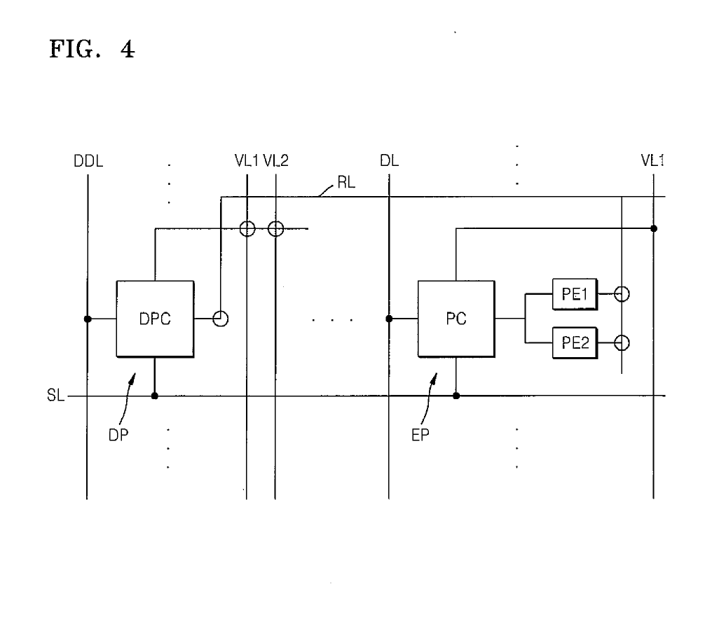

FIGS. 4, 5, and 6 illustrate a method of repairing a defective pixel by using a repair line according to an embodiment of the present invention.

Referring to FIG. 4, the emission pixel EP and the dummy pixel DP are at the same pixel row. The embodiment illustrated in FIG. 4 shows the dummy pixel DP formed in the dummy area DA at the left-side of the display area AA.

The repair line RL is along a pixel row and is insulated (or electrically separated) from the emission pixel EP and the dummy pixel DP. An insulation layer is between the repair line and each of the light-emitting devices of the emission pixel EP and a dummy pixel circuit DPC of the dummy pixel DP to insulate the repair line therefrom. The repair line RL may be electrically coupled to the light-emitting device of the emission pixel EP and the dummy pixel circuit DPC of the dummy pixel DP by a laser short during a repairing process.

The emission pixel EP includes a pixel circuit PC, and a light-emitting device that emits light and is coupled to the pixel circuit. The pixel circuit PC may include at least one thin film transistor and at least one capacitor. The light-emitting device may be an organic light-emitting device including an anode, a cathode, or an emission layer between the anode and the cathode. The anode of the light-emitting device may be divided such that the light-emitting device may include a plurality of sub-light-emitting devices. FIG. 4 illustrates an embodiment in which the anode is divided into two, such that the light-emitting device includes two sub-light-emitting devices, namely, a first sub-light-emitting device PE1 and a second sub-light-emitting device PE2. Cathodes of the first and the second sub-light-emitting devices PE1 and PE2 may be a common electrode formed on the entire substrate. The emission pixel EP is coupled to a first voltage line VL1 supplying the first voltage ELVDD1.

The dummy pixel DP includes the dummy pixel circuit DPC, but does not include the light-emitting device. However, embodiments of the present invention are not limited thereto, and the dummy pixel DP may include a dummy light-emitting device. In that case, the dummy light-emitting device may not actually emit light and may act as a circuit device. For example, the dummy light-emitting device may act as a capacitor. The dummy pixel circuit DPC of the dummy pixel DP may be the same as or different from the pixel circuit PC of the emission pixel EP.

The dummy area DA may include the first voltage line VL1 supplying the first voltage ELVDD1 and the second voltage line VL2 supplying the second voltage ELVDD2, and an insulating layer between the dummy pixel DP and each of the first voltage line VL1 and the second voltage line VL2 to insulate the dummy pixel DP therefrom. The dummy pixel DP may be electrically coupled to the first voltage line VL1 or the second voltage line VL2 by a laser short during the repairing process.

The first voltage line VL1 in the display area AA and the first voltage line VL1 in the dummy area DA may be coupled to each other to receive the same first voltage ELVDD1. Alternatively, the first voltage line VL1 in the display area AA and the first voltage line VL1 in the dummy area DA may be separated from each other and receive the same first voltage ELVDD1 from the power supply unit 170. The first voltage line VL1 may be in a vertical direction (e.g., in a pixel column direction).

The second voltage line VL2 may be in a vertical direction parallel to the first voltage line VL1 in the dummy area DA. The second voltage line VL2 may receive the second voltage ELVDD2 from the power supply unit 170.

The dummy pixel DP may be coupled to the first voltage line VL1 or the second voltage fine VL2, depending on the kind of the defect of the emission pixel EP.

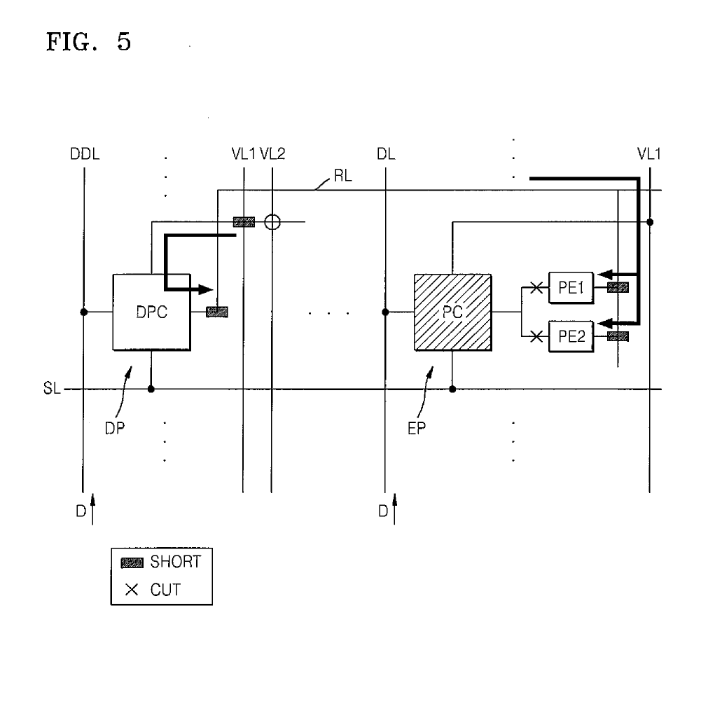

FIG. 5 illustrates a repairing method when the pixel circuit PC of the emission pixel EP is defective.

Referring to FIG. 5, the first sub-light-emitting device PE1 and the second sub-light-emitting device PE2 are separated (e.g., electrically separated) from the emission pixel EP. To this end, a connection between each anode of the first and the second sub-light-emitting devices PE1 and PE2 and the pixel circuit PC may be severed. Furthermore, anodes of the first sub-light-emitting device PE1 and second sub-light-emitting device PE2 may be each coupled to the repair line RL by a laser short.

Then, the dummy pixel circuit DPC of the dummy pixel DP is coupled to the repair line RL and the first voltage line VL1 by using a laser short.

As illustrated in FIG. 5, the same data signal as the data signal D applied to the data line DL of the emission pixel EP is applied to the dummy data line DDL of the dummy pixel DP at the scan timing. Accordingly, when the dummy pixel DP turns on according to the logic level of the data signal D, the first voltage ELVDD1 is applied to each anode of the first sub-light-emitting device PE1 and the second sub-light-emitting device PE2 through the repair line RL to emit light at a normal brightness.

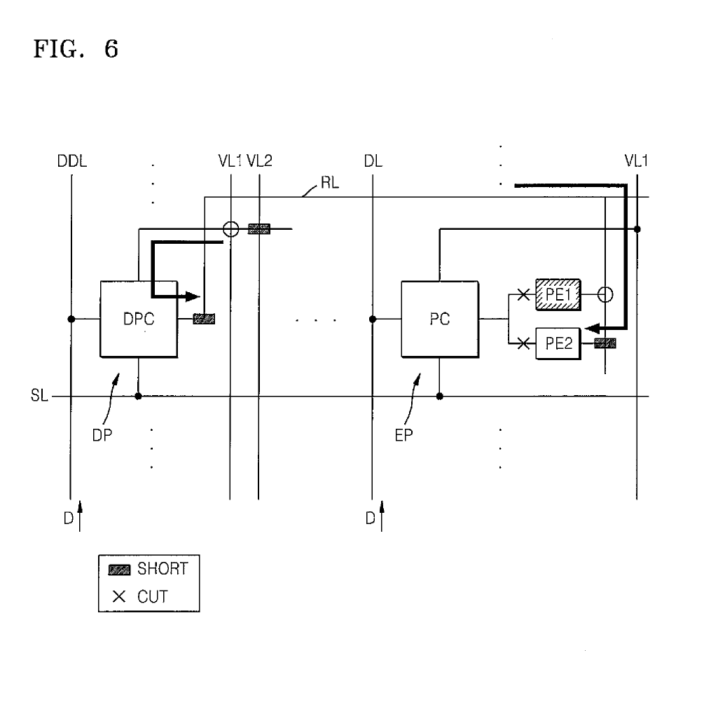

FIG. 6 illustrates a repairing method when the sub-light-emitting device of the emission pixel EP is defective.

Referring to FIG. 6, when the first sub-light-emitting device PE1 of the emission pixel EP has a short defect, the first sub-light-emitting device PE1 and the second sub-light-emitting device PE2 are separated (e.g., electrically separated) from the emission pixel EP. To this end, a connection between each anode of the first and the second sub-light-emitting devices PE1 and PE2 and the pixel circuit PC may be severed. Also, a normal and defect-free anode of the second sub-light-emitting device PE2 is coupled to the repair line RL by a laser short.

Furthermore, the dummy pixel circuit DPC of the dummy pixel DP is coupled to each of the repair line RL and the second voltage line VL2 by a laser short.

The display apparatus 100 is driven by a constant-voltage driving method. When one of the plurality of sub-light-emitting devices PE1 and PE2 included in the emission pixel EP is defective, the defective sub-light-emitting device may be separated (e.g., electrically separated) from the emission pixel EP to blacken the same. In this regard, a surface area of the anode decreases by half, such that the entire surface area of the light-emitting device decreases by half, and thus the resistance of the emission layer increases to a magnitude that is twice the original magnitude. Accordingly, a half of driving current flows through remaining sub-light-emitting devices, thereby decreasing brightness of the emission pixel EP by 50%.

In the embodiments of the present invention, when the defect of the emission pixel EP is a defect of the light-emitting device caused by a short between the anode and the cathode, the second voltage ELVDD2 having a higher level, for example, a level that is twice as large as the level of the first voltage ELVDD1 supplied to a normal emission pixel EP, is supplied to the light-emitting device of the defective emission pixel EP from the dummy pixel DP, such that the defective emission pixel may emit light at normal brightness. A voltage level of the second voltage ELVDD2 may be determined according to the number of the sub-light-emitting devices of the emission pixel EP and a surface area of blackened sub-light-emitting devices.

As illustrated in FIG. 6, in the dummy data line DDL of the dummy pixel DP, a data signal D, which is the same signal as the data signal D applied to the data line DL of the emission pixel EP, is applied at the scan time (during the scan period). Accordingly, when the dummy pixel DP turns on according to the logic level of the data signal D, the second voltage ELVDD2 may be applied to the anode of the second sub-light-emitting device PE2 through the repair line RL, such that the emission pixel EP may emit light at normal brightness.

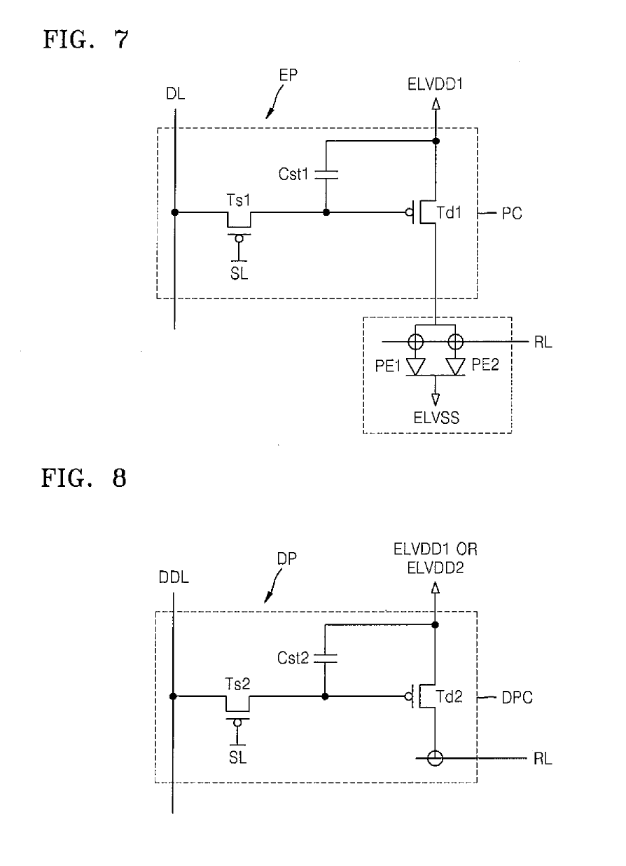

FIG. 7 is a circuit diagram illustrating an emission pixel EP according to an embodiment of the present invention.

Referring to FIG. 7, the emission pixel EP includes a pixel circuit PC including first and second transistors Ts1 and Td1 and a capacitor Cst1, and a first sub-light-emitting device PE1 and a second sub-light-emitting device PE2 coupled to the pixel circuit PC.

The first transistor Ts1 has a gate electrode coupled to the scan line SL, a first electrode coupled to the data line DL, and a second electrode coupled to the gate electrode of the second transistor Td1.

The second transistor Td1 has a gate electrode coupled to the second electrode of the first transistor Ts1, a first electrode coupled to the first voltage line VL1 to receive the first voltage ELVDD1, and a second electrode coupled to each of the anodes of the first sub-light-emitting device PE1 and the second sub-light-emitting device PE2.

The first capacitor Cst1 has a first electrode coupled to the second electrode of the first transistor Ts1 and the gate electrode of the second transistor Td1, and a second electrode coupled to the first voltage line VL1 to receive the first voltage ELVDD1.

The first sub-light-emitting device PE1 and the second sub-light-emitting device PE2 respectively may be an organic light-emitting device (e.g., an organic light-emitting diode) OLED including a first electrode, a second electrode opposite to the first electrode, and an emission layer between the first electrode and the second electrode. The first electrode and the second electrode may respectively be an anode and a cathode. The anode may be coupled to the second electrode of the second transistor Td1, and the cathode may be coupled to the second power supply to receive the second power source voltage ELVSS. The anode of each of the first sub-light-emitting device PE1 and the second sub-light-emitting device PE2 may be insulated (or electrically separated) from the repair line RL by having an insulating layer interposed therebetween.

FIG. 8 is a circuit diagram illustrating a dummy pixel DP according to an embodiment of the present invention.

Referring to FIG. 8, the dummy pixel DP includes a dummy pixel circuit DPC including third and fourth transistors Ts2 and Td2, respectively, and a capacitor Cst2.

The third transistor Ts2 has a gate electrode coupled to the scan line SL, a first electrode coupled to the dummy data line DDL, and a second electrode coupled to the gate electrode of the fourth transistor Td2.

The fourth transistor Td2 has a gate electrode coupled to the second electrode of the third transistor Ts2, and a first electrode is insulated (or electrically separated) from the first voltage line VL1 and the second voltage line VL2 by an insulating layer therebetween. The first electrode is electrically coupled to the first voltage line VL1 or the second voltage line VL2 by a laser short to receive the first voltage ELVDD1 or the second voltage ELVDD2. The second electrode of the fourth transistor Td2 is insulated (or electrically separated) from the repair line RL by an insulating layer therebetween. The second electrode of the fourth transistor Td2 may be electrically coupled to the repair line RL by a laser short.

The second capacitor Cst2 has a first electrode coupled to the second electrode of the third transistor Ts2 and the gate electrode of the fourth transistor Td2, and is insulated (or electrically separated) from the first voltage line VL1 and the second voltage line VL2 by an insulating layer therebetween. The first electrode may be electrically coupled to the first voltage line VL1 or the second voltage line VL2 by a laser short to receive the first voltage ELVDD1 or the second voltage ELVDD2.

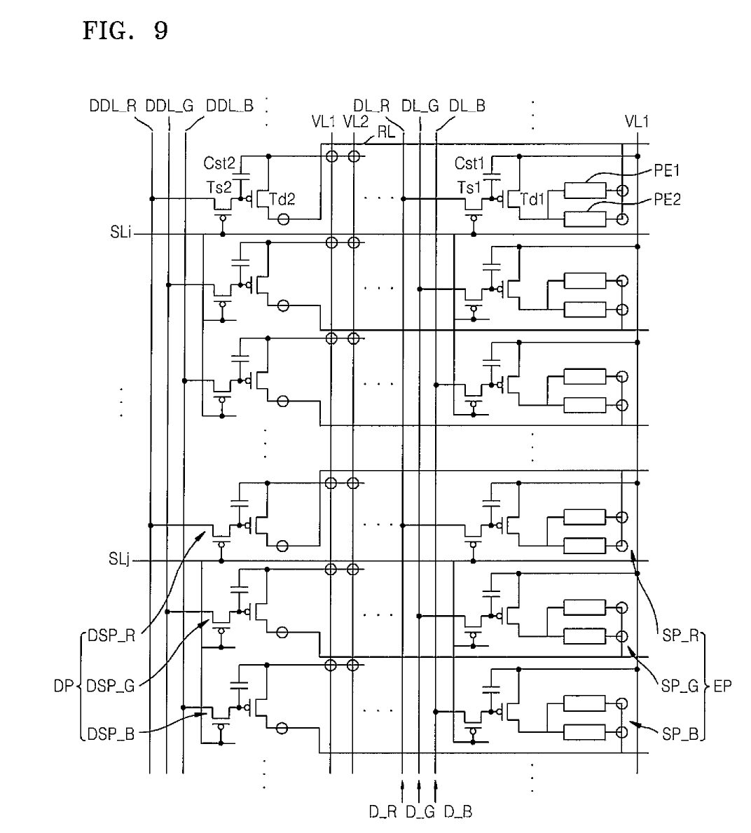

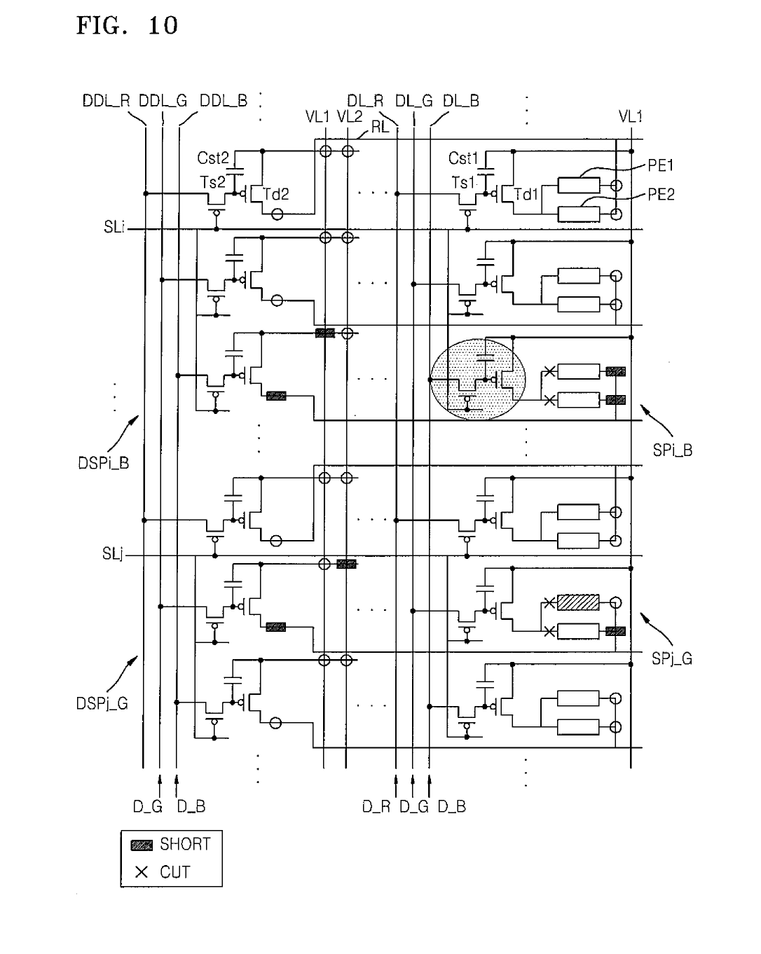

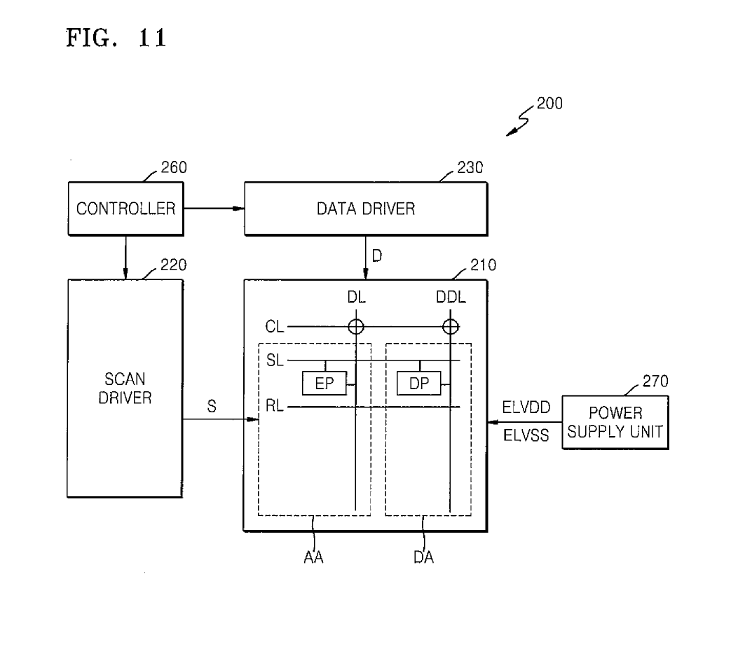

FIGS. 9 and 10 illustrate a method of repairing a defective pixel by using (utilizing) a repair line according to an embodiment of the present invention.

The embodiment of FIG. 9 illustrates a case in which the emission pixel EP includes a plurality of sub-emission pixels SP and the dummy pixel DP includes a plurality of sub-dummy pixels DSP. For example, the emission pixel EP may include a red sub-emission pixel SP_R, a green sub-emission pixel SP_G, and a blue sub-emission pixel SP_B. Each sub-emission pixel SP may have a structure illustrated in FIG. 7. The dummy pixel DP may include a red sub-dummy pixel DSP_R, a green sub-dummy pixel DSP_G, and a blue sub-dummy pixel DSP_B. Each sub-dummy pixel DSP may have a structure illustrated in FIG. 8. Each sub-dummy pixel DSP is in the same pixel row as the corresponding sub-emission pixel SP.

FIGS. 9 and 10 illustrate sub-pixels emitting red, blue, and green colors, but the present invention is not limited thereto, and each unit pixel may include one or more sub-pixels emitting colors other than red, blue, and green, such as white.

The plurality of sub-emission pixels SP forming the emission pixel EP and the plurality of sub-dummy pixels DSP forming the dummy pixel DP, which are coupled to the same scan line SL, receive the same scan signal S. For example, the plurality of sub-emission pixels (SP_R, SP_G, and SP_B) and the plurality of sub-dummy pixels (DSP_R, DSP_G, and DSP_B) coupled to an i^{th} scan line SLi concurrently receive the same scan signal Si (e.g., at the same time).

Each of the sub-emission pixels (SP_R, SP_G, and SP_B) may include the first sub-light-emitting device PE1 and the second sub-light-emitting device PE2 by division of the anode. Each of the sub-emission pixels (SP_R, SP_G, and SP_B) is coupled to the first voltage line VL1.

The sub-emission pixels (SP_R, SP_G, and SP_B) are each coupled to separate data lines (DL_R, DL_G, and DL_B, respectively). A data signal (D_R, D_G, or D_B) is synchronized with the scan signal Si to be applied to each data line (DL_R, DL_G, or DL_B).

The sub-dummy pixels (DSP_R, DSP_G, and DSP_B) are each coupled to separate data lines (DDL_R, DDL_G, and DDL_B, respectively). Data signals (D_R, D_G, and D_B) applied to the repaired sub-emission pixels (SP_R, SP_G, and SP_B) may be applied to the dummy data lines (DDL_R, DDL_G, and DDL_B). Each of the sub-dummy pixels (DSP_R, DSP_G, and DSP_B) is insulated (or electrically separated) from each of the first voltage line VL1 and the second voltage line VL2. The second voltage line VL2 supplies the second voltage ELVDD2, which has a level that is twice as high as that of the first voltage ELVDD1.

The repair line RL is at each pixel row, and the repair line RL is insulated (or electrically separated) from the anode of the sub-emission pixel SP and the fourth transistor Td2 of the sub-dummy pixel DSP by an insulating layer therebetween. The repair line RL may provide a pathway for transmitting the first voltage ELVDD1 or the second voltage ELVDD2, which is applied to the sub-dummy pixel DSP according to a logic level of the dummy data signal DD applied to the dummy pixel DP, to the repaired (or defective) sub-emission pixel SP.

The embodiment of FIG. 9 illustrates each anode of the first sub-light-emitting device PE1 and the second sub-light-emitting device PE2 of the sub-emission pixel SP as coupled to the second transistor Td1 and is insulated (or electrically separated) from the repair line RL. Also, the embodiment of FIG. 9 illustrates the fourth transistor Td2 of the sub-dummy pixel DSP as insulated (or electrically separated) from the repair line RL and the fourth transistor Td2, and the second capacitor Cst2 respectively insulated (or electrically separated) from the first voltage line VL1 and the second voltage line VL2.

Hereinafter, a normal driving of the sub-emission pixel SP as a normal pixel will be described.

The first transistor Ts1 of the sub-emission pixel SP is turned on when a scan signal S is supplied from the scan line SL and transmits the data signal D supplied to the data line DL. The first capacitor Cst1 is charged with a voltage corresponding to data signal D and the second transistor Td1 is turned on-off according to the logic level of the data signal D. When the second transistor Td1 is turned on, the first voltage ELVDD1 is applied to each anode of the first sub-light-emitting device PE1 and the second sub-light-emitting device PE2, such that the first sub-light-emitting device PE1 and the second sub-light-emitting device PE2 emit light. When the second transistor Td1 is turned off, each of the first sub-light-emitting device PE1 and the second sub-light-emitting device PE2 displays black.

FIG. 10 illustrates a method of repairing defects of the sub-emission pixel SP.

First, when the blue sub-emission pixel SPi_B coupled to the i^{th} scan line SLi has pixel circuit defects, the first sub-light-emitting device PE1 and the second sub-light-emitting device PE2 are separated (e.g., electrically separated) from the blue sub-emission pixel SPi_B. To this end, a connection between the second transistor Td1 and the anodes of the first and the second sub-light-emitting devices PE1 and PE2 may be severed. Also, the anodes of the first sub-light-emitting device PE1 and the second sub-light-emitting device PE2 are each coupled to the repair line RL by a laser short.

The fourth transistor Td2 of the blue sub-dummy pixel DSPi_B at the same row as the blue sub-emission pixel SPi_B is coupled to each of the repair line RL and the first voltage line VL1 by a laser short.

Hereinafter, driving of the pixel circuit defective blue sub-emission pixel SPi_B repaired by the blue sub-dummy pixel DSPi_B will be described in more detail.

The third transistor Ts2 of the blue sub-dummy pixel DSPi_B is turned on when the scan signal Si is supplied from the i^{th} scan line SLi to transmit the dummy data signal supplied to the dummy data line DDL_B. The dummy data signal is the data signal D_B supplied to the data line DL_B coupled to the blue sub-emission pixel SPi_B. A voltage corresponding to the dummy data signal D_B is charged in the second capacitor Cst2 and the fourth transistor Td2 is turned on-off according to the logic level of the dummy data signal D_B. When the fourth transistor Td2 is turned on, the first voltage ELVDD1 is output as the repair line RL. The first voltage ELVDD1 takes a detour to be applied to the anodes of the first sub-light-emitting device PE1 and the second sub-light-emitting device PE2 of the blue sub-emission pixel SPi_B through the repair line RL. Accordingly, the first sub-light-emitting device PE1 and the second sub-light-emitting device PE2 emit light at equal brightness as nearby sub-light-emitting devices. When the fourth transistor Td2 of the blue sub-dummy pixel DSPi_B is turned off, the first sub-light-emitting device PE1 and the second sub-light-emitting device PE2 display black.

Then, when the first sub-light-emitting device PE1 of the green sub-emission pixel SPj_G coupled to the j^{th} scan line SLj is defective, the first sub-light-emitting device PE1 and the second sub-light-emitting device PE2 are separated (e.g., electrically separated) from the green sub-emission pixel SPj_G. To this end, a connection between the second transistor Td1 and the anodes of the first and the second sub-light-emitting device PE1 and PE2 may be severed. Then, an anode of the defect-free second sub-light-emitting device PE2 is coupled to the repair line RL by a laser short.

The fourth transistor Td2 of the green sub-dummy pixel DSPj_G at the same pixel row as the green sub-emission pixel SPj_G is coupled to each of the repair line RL and the second voltage line VL2 by a laser short.

Hereinafter, driving a green sub-emission pixel SPj_G having a defective sub-light-emitting device, which is repaired by the green sub-dummy pixel DSPj_G, will be described.

The third transistor Ts2 of the green sub-dummy pixel DSPj_G is turned on when the scan signal Si is supplied from the j^{th} scan line SLj to transmit the dummy data signal supplied to the dummy data line DDL_B. The dummy data signal is a data signal D_G supplied to the data line DL_G coupled to the green sub-emission pixel SPj_G. The second capacitor Cst2 is charged with a voltage corresponding to the dummy data signal D_G, and the fourth transistor Td2 is turned on-off according to the logic level of the dummy data signal D_B. When the fourth transistor Td2 is turned on, the second voltage ELVDD2 is output through the repair line RL. The second voltage ELVDD2 takes a detour to be applied to the anode of the second sub-light-emitting device PE2 of the green sub-emission pixel SPj_G through the repair line RL. The magnitude of the second voltage ELVDD2 is twice as large as the magnitude of the first voltage ELVDD1 and thus, the second sub-light-emitting device PE2 may emit light at the same brightness as that of a nearby sub-emission pixel without reducing the brightness. When the fourth transistor Td2 of the green sub-dummy pixel DSPj_G is turned off, the second sub-light-emitting device PE2 displays black.

The embodiment of FIG. 10 illustrates two defective sub-emission pixels in the same pixel row for convenient description; however, sub-emission pixels at different pixel columns may be repaired by sub-dummy pixels at the same pixel row.

FIG. 11 is a block diagram schematically illustrating a display apparatus according to an embodiment of the present invention.

Referring to FIG. 11, a display apparatus 200 may include a display panel 210, a scan driver 220, a data driver 230, a controller 260, and a power supply unit 270. The embodiment illustrated in FIG. 11 is different from the embodiment illustrated in FIG. 1 in that the dummy data signal is not applied directly to the dummy pixel DP from the data driver 230, but is applied from the data line DL coupled to the emission pixel EP through a coupling (e.g., connecting) line CL.

The coupling line CL traverses the data line DL and the dummy data line DDL in a non-display area near the display area AA, and is insulated (or electrically separated) from the data line DL and the dummy data line DDL by an insulating layer therebetween. Then, when the defective emission pixel EP is repaired by the dummy pixel DP, the coupling line CL may be electrically coupled to the data line DL and the dummy data line DDL by a laser short. Accordingly, the data signal applied to the data line DL coupled to the defective emission pixel EP may be applied to the dummy data line DDL coupled to the dummy pixel DP through the coupling line CL.

In the embodiment of FIG. 11, data driver 230 may not generate and transmit the dummy data signal to the dummy pixel DP and thus, the configuration of the data driver 230 may be simplified.

Other configurations of the display apparatus 200 are similar to that of the display apparatus 100 illustrated in FIG. 1 and thus, the detailed description thereof will be omitted.

As described above, according to the one or more of the above embodiments of the present invention, defective pixels may be easily repaired and thus, the defective pixels may be normally driven to increase the production yield of the display apparatus.

Also, brightness variation between a repaired pixel and a normal pixel, which occurs due to driving method of the display apparatus, may be reduced to provide a display apparatus with excellent display quality.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made herein without departing from the spirit and scope of the present invention as defined by the following claims, and equivalents thereof.

What is claimed is:

1. An organic light emitting display apparatus comprising:
an emission pixel comprising a pixel circuit coupled to a first voltage line configured to apply a first voltage and to transmit the first voltage according to a logic level of a data signal applied in units of a subfield, and a plurality of sub-light-emitting devices coupled to the pixel circuit and configured to receive the first voltage to emit light;
a dummy pixel coupled to the first voltage line or a second voltage line configured to apply a second voltage having a level higher than that of the first voltage; and
a repair line coupling a first sub-light-emitting device among the plurality of the sub-light-emitting devices separated from the emission pixel to the dummy pixel to provide a pathway for transmitting the first voltage or the second voltage to the first sub-light-emitting device according to a logic level of a dummy data signal.

2. The organic light emitting display apparatus of claim 1, wherein the pixel circuit of the emission pixel comprises:
a first thin film transistor configured to be turned on by a scan signal applied to a scan line and to transmit the data signal applied to a data line;
a second thin film transistor configured to be turned on according to a logic level of the data signal and to transmit the first voltage to the plurality of sub-light-emitting devices; and
a first capacitor configured to store a voltage corresponding to the data signal.

3. The organic light emitting display apparatus of claim 1, wherein each of the sub-light-emitting devices comprises:
a first electrode coupled to the pixel circuit;
a second electrode opposite to the first electrode; and
an emission layer between the first electrode and the second electrode.

4. The organic light emitting display apparatus of claim 1, wherein the dummy pixel comprises:
a third thin film transistor configured to be turned on by a scan signal applied to a scan line and to transmit the dummy data signal applied to a dummy data line;
a fourth thin film transistor configured to be turned on according to a logic level of the dummy data signal and to transmit the first voltage or the second voltage to the repair line; and
a second capacitor configured to store a voltage corresponding to the dummy data signal.

5. The organic light emitting display apparatus of claim 4, wherein the dummy data signal is a data signal applied to the emission pixel.

6. The organic light emitting display apparatus of claim 1, wherein
the first sub-light-emitting device comprises all of the plurality of the sub-light-emitting devices, and wherein
the dummy pixel is coupled to the first voltage line and is configured to transmit the first voltage to the first sub-light-emitting device through the repair line.

7. The organic light emitting display apparatus of claim 1, wherein
the first sub-light-emitting device comprises some of the plurality of the sub-light-emitting devices, and wherein
the dummy pixel is coupled to the second voltage line and is configured to transmit the second voltage to the first sub-light-emitting device through the repair line.

8. The organic light emitting display apparatus of claim 1, wherein
the dummy pixel is at a same row as the emission pixel and configured to concurrently receive a same scan signal as that of the emission pixel.

9. The organic light emitting display apparatus of claim 1, wherein
the emission pixel is configured to receive a data signal from a data line,
the dummy pixel is configured to receive a dummy data signal from a dummy data line, wherein
the dummy data signal is a signal supplied to the dummy data line through a coupling line coupled to each of the data line and the dummy data line.

10. The organic light emitting display apparatus of claim 1 further comprising:
a scan driver configured to supply a scan signal to a scan line coupled to the emission pixel and the dummy pixel;
a data driver configured to supply a data signal through a data line coupled to the emission pixel and a dummy data signal through a dummy data line coupled to the dummy pixel; and
a power supplier configured to supply the first voltage and the second voltage.

11. The organic light emitting display apparatus of claim 1, wherein one frame comprises a plurality of subfields, and the organic light emitting display apparatus is configured to display a gray level by selectively illuminating the emission pixel according to a logic level of the data signal supplied to each subfield to control emission time.

12. An organic light emitting display apparatus, which displays a gray level by forming one frame into a plurality of subfields, the organic light emitting display apparatus comprising:
a display panel comprising an emission pixel in a display area comprising a plurality of sub-light-emitting devices in which emission is controlled according to a logic level of a data signal supplied at each subfield, a dummy pixel in a dummy area adjacent the display area and configured to repair defects of the emission pixel, and a repair line electrically separated from the emission pixel and the dummy pixel; and
a power supplier configured to supply a first power supply voltage, the first power supply voltage being a first voltage or a second voltage having a higher level than that of the first voltage and a second power supply voltage having a lower level than that of the first power supply voltage.

13. The organic light emitting display apparatus of claim 12, wherein the emission pixel comprises:
a first thin film transistor configured to be turned on by a scan signal supplied to a scan line and to transmit a data signal supplied to a data line;
a second thin film transistor configured to be turned on according to a logic level of the data signal and to transmit the first voltage to the plurality of the sub-light-emitting devices; and
a first capacitor configured to store a voltage corresponding to the data signal.

14. The organic light emitting display apparatus of claim 13, wherein each sub-light-emitting device comprises:
a first electrode coupled to the second thin film transistor;
a second electrode opposite to the first electrode; and
an emission layer between the first electrode and the second electrode.

15. The organic light emitting display apparatus of claim 12, wherein the dummy pixel comprises:
a third thin film transistor configured to be turned on by a scan signal supplied to a scan line and to transmit a dummy data signal supplied to a dummy data line;
a fourth thin film transistor configured to be turned on according to a logic level of the dummy data signal and to transmit the first voltage or the second voltage through the repair line; and
a second capacitor configured to store a voltage corresponding to the dummy data signal.

16. The organic light emitting display apparatus of claim 12, wherein when a pixel circuit of the emission pixel is defective,
the plurality of the sub-light-emitting devices are configured to be electrically separated from the emission pixel and to be each electrically coupled to the repair line, and
the dummy pixel is configured to be electrically coupled to each of a first voltage line configured to supply the first voltage and the repair line.

17. The organic light emitting display apparatus of claim 12, wherein when one of the plurality of sub-light-emitting devices of the emission pixel is defective,
the plurality of sub-light-emitting devices are configured to be electrically separated from the emission pixel, and sub-light-emitting devices other than the defective sub-light-emitting device are configured to be electrically coupled to the repair line, and wherein
the dummy pixel is electrically coupled to each of a second voltage line configured to supply the second voltage and the repair line.

18. The organic light emitting display apparatus of claim 12, further comprising:
a scan driver configured to supply a scan signal to a scan line coupled to the emission pixel and the dummy pixel; and
a data driver configured to supply a data signal to a data line coupled to the emission pixel and to supply a dummy data signal to a dummy data line coupled to the dummy pixel.

19. The organic light emitting display apparatus of claim 12, wherein a dummy data signal is a data signal to be applied to the emission pixel.

20. The organic light emitting display apparatus of claim 12, further comprising:
a scan driver configured to supply a scan signal to a scan line coupled to the emission pixel and the dummy pixel; and
a data driver configured to supply a data signal to a data line coupled to the emission pixel; and
a coupling line coupled to the data line and a dummy data line which is coupled to the dummy pixel and configured to supply the data signal supplied to the data line to the dummy data line.
